(19) United States
(12) Patent Application Publication
(10) Pub. No.: US 2026/0204639 A1
(43) Pub. Date: Jul. 16, 2026

(54) ELECTROLYTE FOR HIGH-RATE AND HIGH-VOLTAGE LITHIUM METAL BATTERIES

(71) Applicant: The Chinese University of Hong Kong, Hong Kong (CN)

(72) Inventors: Yi-Chun LU, Hong Kong (CN); Jingwei XIANG, Hong Kong (CN)

(21) Appl. No.: 19/451,304

(22) Filed: Jan. 16, 2026

Related U.S. Application Data
(60) Provisional application No. 63/746,055, filed on Jan. 16, 2025.

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/0028

(57) ABSTRACT

A low-cost electrolyte for lithium metal batteries based on crystal regulation at the electrode-electrolyte interface is provided. The electrolyte includes ester solvents with a low melting point (<−40° C.) and low dielectric constant (<10) as the co-solvent, grain refiners and inhibitors as additives. The electrolyte facilitates the formation of a cathode-electrolyte interphase (CEI) and solid-electrolyte interphase (SEI) including a plurality of fine-grained LiF crystals at the electrode-electrolyte interface, thereby enhancing the stability of the SEI and CEI while reducing interfacial resistance. The LiNi_{0.8}Mn_{0.1}Co_{0.1}O₂ (NCM811)∥Li battery including the electrolyte retains 76.0% of its capacity after 1000 cycles at a current density of 4 C for charging and 10 C for discharging (1 C=220 mA g⁻¹), within a voltage range of 3-4.7 V. The electrolyte significantly enhances the cycling stability, rate performance, and low-temperature performance of HV-LMBs without increasing the cost.

### CROSS-REFERENCE TO RELATED APPLICATION

This application claims the benefit of U.S. Provisional Ser. No. 63/746,055, filed Jan. 16, 2025, which is hereby incorporated by reference in its entirety including any tables, figures, or drawings.

### BACKGROUND OF THE INVENTION

Since Sony launched the first commercial lithium-ion battery (LIB) in 1991, LIBs have been widely used in portable electronics, electric vehicles, energy storage systems and other fields. After decades of development, LIBs have made significant progress in cycling stability and safety.^{1,2} However, the energy density of LIBs is constrained by graphite anodes, which have a theoretic capacity of only 372 mAh g⁻¹. With the rapid development of electric vehicles and emerging applications, traditional LIBs are unable to meet the increasing demands for next-generation energy storage systems, such as high energy density, high power density, and excellent low-temperature performance.^{3,4} In this context, lithium metal batteries (LMBs) with high energy density (the theoretical specific capacity of lithium metal anode is as high as 3,860 mAh g⁻¹) have become the brightest star among various energy storage systems. Especially when the charging cut-off voltage of LMBs is further increased (>4.3 V, high-voltage lithium metal batteries, HV-LMBs), it can enhance the energy density of the batteries, with the potential to achieve a breakthrough in energy density exceeding 500 Wh kg⁻¹.^{5,6} However, the large-scale application of HV-LMBs still faces numerous challenges, such as harmful phase transformations in the cathode at high voltage, continuous decomposition of the electrolyte under high voltage, and the growth of Li dendrites.^{7,8} Therefore, there is an urgent need for an effective strategy to address the challenges associated with HV-LMBs.

Compared to other approaches, electrolyte optimization offers advantages such as simplicity of operation, ease of scalability in production, and the ability to enhance both cathode and anode performance simultaneously.^{9,10} Therefore, electrolyte optimization stands out as one of the most promising strategies for advancing HV-LMBs applications. Current efforts to address HV-LMBs challenges primarily involve increasing Li salt concentration or incorporating large amounts of highly-fluorinated diluents to improve electrolyte stability and the electrode-electrolyte interface.^{11,12} However, these strategies provide limited improvements in the cycle life of HV-LMBs, and the use of large amounts of Li salts or fluorinated diluents significantly raises the cost of the electrolyte. Furthermore, these electrolytes often suffer from high viscosity or low ionic conductivity, resulting in poor rate capability and low-temperature performance, which fail to satisfy the demands of applications.^{13,14} Therefore, there is an urgent need to develop a low-cost electrolyte that enables the HV-LMBs to achieve long cycling life, excellent rate performance, and good low-temperature performance.

There continues to be a need in the art for improved compositions for electrolytes for high-rate and high-voltage lithium metal batteries.

### BRIEF SUMMARY OF THE INVENTION

According to an embodiment of the subject invention, an electrolyte for lithium metal batteries comprises one or more lithium salts selected from the group consisting of LiPF₆, Li(FSO₂)₂N, LiC(SO₂CF₃)₃, CF₃SO₃Li, LiN(SO₂CF₃)₂, lithium bisoxalatodifluorophosphate (LiDFBOP), Lithium difluoro(oxalato)borate (LiDFOB), LiB(C₂O₄)₂, LiBF₄, LiPF₃(CF₃)₃, LiPF₄(CF₃)₂, LiPF₅(CF₃), LiPF₃(CF₂CF₃)₃, LiNO₃, LiClO₄, LiAsF₆, Lithium trifluoromethanesulfonate (LiOTf), LiCF₃SO₃, LiCl, LiF, LiBr, LiI, and their mixtures; organic ester solvents; a grain refiner; an inhibitor selected from the group consisting of Li₃N, LiF, Li₂CO₃, LiNO₃, LiPO₂F₂, HN(SO2F)₂, Li₂O, Li₂C₂O₄, Li₂S, CH₂O₂NF₃S, LiBF₄, and their mixtures; and a film-forming additive selected from fluoroethylene carbonate, 1,3,2-dioxathiolane 2,2-dioxide, vinylene carbonate, vinylethylene carbonate, propylene sulfite, ethylene sulfate, prop-1-ene-1,3-sultone, methylene methanedisulfonate, and their mixtures. Moreover, the organic ester solvents account for 0.5% to 100% of a volume of the electrolyte. A concentration of the grain refiner is in a range between 0.05 M and 3 M. A concentration of the inhibitor is in a range between 0.02 M and 3 M. The film-forming additive accounts for 0% to 99.5% of a volume of the electrolyte.

In another embodiment, a lithium battery is provided, comprising the electrolyte aforementioned; a cathode; and an anode. The cathode is made from a material selected from lithium-rich layered oxides, nickel-rich layered oxides, spinel oxides, and polyanionic compounds. The lithium-rich layered oxides include xLi₂MnO₃(1−x)·LiMO₂, wherein M is one of Ni, Co, and Mn. The nickel-rich layered oxides include LiNiO₂, LiNi₁₋ₓMₓO₂, Li[Ni_{1-x-y}CoₓMn_{y}]O₂, or Li[Ni_{1-x-y}CoₓAl_{y}]O₂, wherein M is one of Co and Mn. The spinel oxides include LiMn₂₋ₓMO₄, wherein M is one of Ni, Co, and Mn. The polyanionic compounds include phosphates, silicates, or sulfates. The anode is made from a material selected from lithium alloy or lithium metal.

### BRIEF DESCRIPTION OF THE DRAWINGS

FIG. 1 shows the cycling performance of NCM811∥Li batteries comprising LiPF₆-EC/DEC/FEC and LiPF₆-ES at a charge rate of 2 C and a discharge rate of 5 C within a voltage range of 3-4.7 V at 25° C., according to an embodiment of the subject invention.

FIG. 2 shows the Coulombic efficiency of NCM811∥Li batteries comprising LiPF₆-EC/DEC/FEC and LiPF₆-ES at a charge rate of 2 C and a discharge rate of 5 C within a voltage range of 3-4.7 V at 25° C., according to an embodiment of the subject invention.

FIG. 3 shows the cycling performance of NCM811∥Li batteries comprising LiPF₆-ES and LiPF₆-ES-GR at a charge rate of 2 C and a discharge rate of 5 C within a voltage range of 3-4.7 V at 25° C., according to an embodiment of the subject invention.

FIG. 4 shows Nyquist plots and fitting results of NCM811∥Li batteries comprising LiPF₆-ES and LiPF₆-ES-GR after cycles, according to an embodiment of the subject invention.

FIG. 5 shows the cycling performance of NCM811∥Li batteries comprising LiPF₆-ES-GR and LiPF₆-ES-GR-IB at a charge rate of 2 C and a discharge rate of 5 C within a voltage range of 3-4.7 V at 25° C., according to an embodiment of the subject invention.

FIG. 6 shows the cycling performance of NCM811∥Li batteries comprising LiPF₆-EC/DEC/FEC and LiPF₆-ES-GR-IB at a charge rate of 4 C and a discharge rate of 10 C within a voltage range of 3-4.7 V at 25° C., according to an embodiment of the subject invention.

FIG. 7 shows the cycling performance of NCM811∥Li batteries comprising LiPF₆-EC/DEC/FEC and LiPF₆-ES-GR-IB at a charge rate of 0.1 C and a discharge rate of 0.15 C within a voltage range of 3-4.7 V under −40° C., according to an embodiment of the subject invention.

### DETAILED DISCLOSURE OF THE INVENTION

The embodiments of subject invention pertain to an electrolyte for lithium metal batteries.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

It is well known that the solid-electrolyte interphase (SEI) and cathode-electrolyte interphase (CEI) of HV-LMBs play a crucial role in the electrochemical performance of the batteries. LiF, as a significant component of both SEI and CEI, has been shown to significantly enhance their stability. However, due to the inherently low ionic conductivity of LiF, the presence of large LiF particles can hinder the transport of lithium ions through the SEI and CEI, negatively affecting the rate and low-temperature performance of batteries.¹⁵⁻¹⁷

Therefore, the ideal CEI and SEI should consist of numerous fine-grained LiF particles, which can provide a stable structure while also offering excellent lithium-ion conductivity. Based on this consideration, an electrolyte optimization strategy based on crystal regulation at the electrode-electrolyte interface is provided.

According to the embodiments of the subject invention, ester solvents with a low melting point (<−40° C.) and low dielectric constant (<10) are employed as the co-solvent (referred to as ES) to reduce the binding energy between solvents and lithium ions. This approach not only enhances the conductivity of lithium ions in the bulk electrolyte, but also facilitates the participation of more anions in the nucleation of LiF. Additionally, grain refiners (referred to as GR) and inhibitors (referred to as IB) are added to the ester-based electrolyte as additives. The GR suppresses the continuous decomposition of Li salts such as lithium hexafluorophosphate (LiPF₆), which have high adsorption energy to LiF, thereby promoting the formation of fine-grained LiF crystals. In addition, the IB suppresses the excessive decomposition of Li salts during long-term cycling, inhibiting the growth of LiF.

According to the embodiments of the subject invention, a crystal-regulating electrolyte is provided, facilitating the formation of CEI and SEI comprising a plurality of fine-grained LiF crystals. This approach not only ensures the structural stability of the CEI and SEI, but also provides excellent lithium-ion conductivity.

In one embodiment, the LiNi_{0.8}Co_{0.1}Mn_{0.1}O₂ (NCM811)∥Li battery comprising the electrolyte of the subject invention maintained a capacity retention of 76.0% after 1000 cycles at a charge rate of 4 C and a discharge rate of 10 C (1 C=220 mA g⁻¹) within a voltage range of 3-4.7 V. In contrast, the NCM811∥Li battery employing the traditional carbonate electrolyte shows a capacity retention of only 42.7% after 200 cycles under the same test conditions.

Moreover, even at an extremely low temperature of −40° C., the NCM811∥Li battery comprising the electrolyte of the subject invention can maintain a discharge capacity of 105.8 mAh g⁻¹ after 180 cycles. Thus, the goals of simultaneously improving the cycle life, rate capability, and low-temperature performance of HV-LMBs, without increasing electrolyte cost, are achieved.

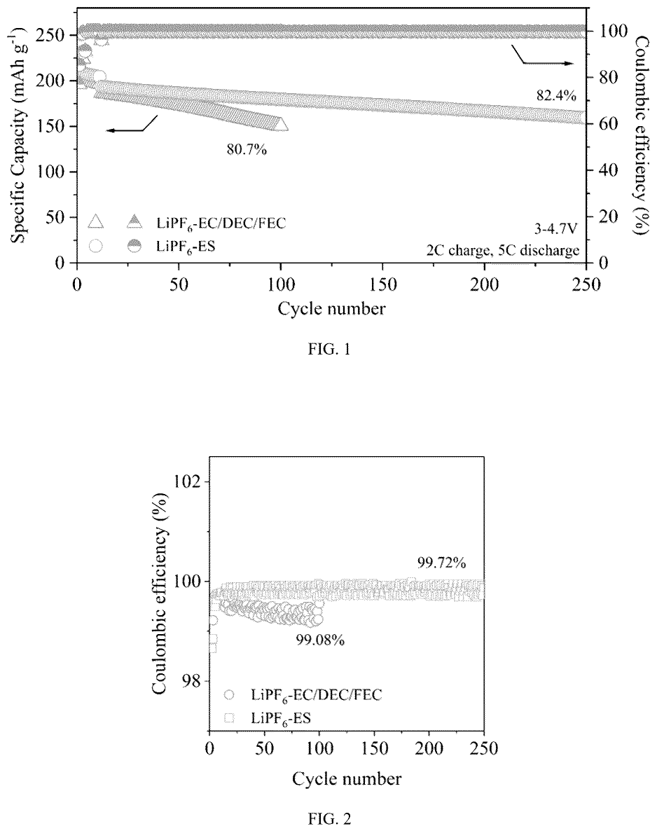

Among various organic solvents, the solvent with low melting point (<−40° C.) and low dielectric constant (<10) was selected as the co-solvent for the electrolyte (referred to as ES). FIG. 1 shows the cycling performance of NCM811∥Li batteries comprising the electrolyte with ES as the co-solvent (LiPF₆ in ES/fluoroethylene carbonate (FEC), 0.1M-3M LiPF₆, 5%-100% ES by volume, 0%-95% FEC by volume, referred to as LiPF₆-ES) and the traditional carbonate electrolyte (1.2 M LiPF₆ in ethylene carbonate (EC)/ethylene carbonate (DEC)/FEC, v/v/v=5:5:1, referred to as LiPF₆-EC/DEC/FEC), respectively. The NCM811∥Li battery comprising the LiPF₆-EC/DEC/FEC showed a capacity retention of only 80.7% after 100 cycles at a charge rate of 2 C and a discharge rate of 5 C within a voltage range of 3-4.7 V.

In contrast, the NCM811∥Li battery comprising the LiPF₆-ES electrolyte achieved a capacity retention of 82.4% after 250 cycles under the same test conditions. Additionally, the LiPF₆-ES electrolyte exhibited an average Coulombic efficiency (CE) of 99.72%, which is significantly higher than the 99.08% obtained by the LiPF₆-EC/DEC/FEC electrolyte as shown in FIG. 2.

Therefore, selecting ES with a low melting point and a low dielectric constant as the co-solvent for the electrolyte can effectively enhance the cycling stability and rate performance of HV-LMBs.

Apart from solvents, additives of the subject invention also play a crucial role in the performance of HV-LMBs. The additive, with a lower adsorption energy for LiF compared to Li salts (referred to as GR) can inhibit the decomposition of Li salts on LiF, thereby inhibiting the continuous growth of LiF grains. Consequently, when the GR is added to the electrolyte as a grain refiner, it can effectively suppress the growth of LiF in the CEI and SEI during cycling, resulting in the formation of numerous fine-grained LiF particles. This alleviates the high interfacial resistance of CEI and SEI caused by the low ionic conductivity of LiF.

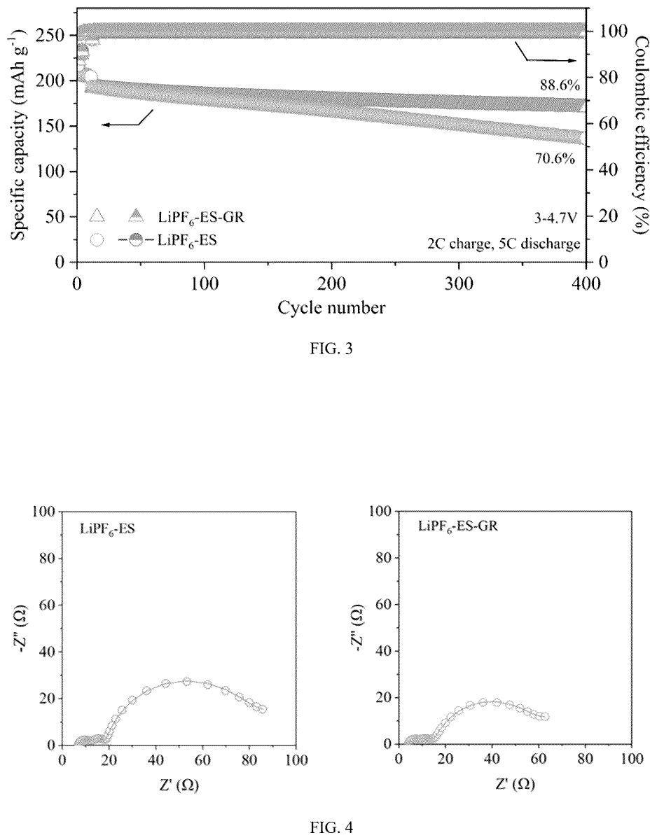

FIG. 3 shows the cycling performance of NCM811∥Li batteries comprising the LiPF₆-ES and the electrolyte with the grain refiner (LiPF₆ and GR in ES/FEC, 0.1M-3M LiPF₆, 0.05M-3M GR, 5%-100% ES by volume, 0%-95% FEC by volume, referred to as LiPF₆-ES-GR), respectively. The NCM811∥Li battery comprising the LiPF₆-ES exhibited a capacity retention of only 70.6% after 400 cycles at a charge rate of 2 C and a discharge rate of 5 C within a voltage range of 3-4.7 V. In contrast, the NCM811∥Li battery using the LiPF₆-ES-GR electrolyte achieved a capacity retention of 88.6% after 400 cycles under the same test conditions. Through the Electrochemical Impedance Spectroscopy (EIS) analysis of the cycled NCM811∥Li batteries as shown in FIG. 4, it is determined that the addition of GR reduced the interfacial resistance of the cycled batteries by 43%, because GR transformed the originally large LiF grains into fine LiF grains, significantly reducing the resistance for lithium-ion transport across the SEI and CEI. Moreover, the formation of a more stable CEI effectively suppressed harmful phase transitions of the NCM811 under high-voltage and high-rate conditions, thereby decreasing the charge transfer resistance of the electrode by 26%. The results demonstrate that combining the ES, which has a low melting point and a low dielectric constant, with the GR significantly enhances the cycle life and rate capability of HV-LMBs.

Although GR can help form a CEI and SEI rich in fine-grained LiF, the continuous decomposition of Li salts at the electrode interface remains inevitable during prolonged cycling (>800 cycles) under extreme conditions of high voltage and high current density, leading to the growth of LiF grains that causes increased interfacial resistance and degradation of battery performance.

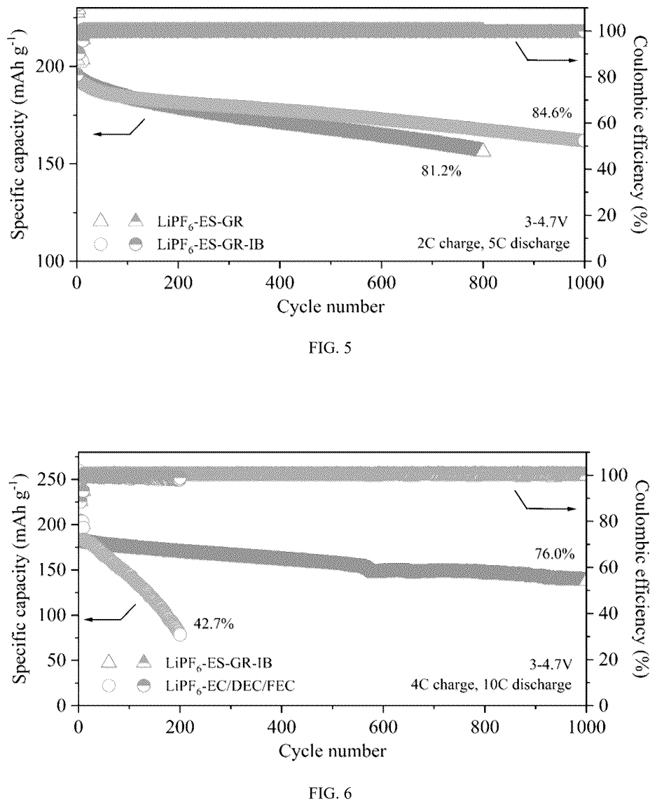

To address this issue, an inhibitor (referred to as IB) is introduced into the electrolyte to suppress the excessive decomposition of lithium salts during long-term cycling, thereby inhibiting the growth of LiF. As shown in FIG. 5, the introduction of IB into the electrolyte (LiPF₆, GR and IB in ES/FEC, 0.1M-3M LiPF₆, 0.05M-3M GR, 0.02M-3M IB, 5%-100% ES by volume, 0%-95% FEC by volume, referred to as LiPF₆-ES-GR-IB) further enhanced the cycling performance of the NCM811∥Li batteries. The NCM811∥Li battery comprising the LiPF₆-ES-GR-IB exhibited a capacity retention of 84.6% after 1000 cycles at a charge rate of 2 C and a discharge rate of 5 C within a voltage range of 3-4.7 V. When the current density is further increased to 4 C for charging and 10 C for discharging, the NCM811∥Li battery comprising the LiPF₆-ES-GR-IB exhibited a capacity retention of 76.0% after 1000 cycles within a voltage range of 3-4.7 V as shown in FIG. 6.

In contrast, the NCM811∥Li battery comprising the traditional LiPF₆-EC/DEC/FEC showed a capacity retention of only 42.7% after 200 cycles under the same test conditions.

These results demonstrate that the addition of IB effectively suppressed the excessive decomposition of Li salts and the growth of LiF grains under extreme testing conditions, further enhancing the cycle life and rate performance of HV-LMBs.

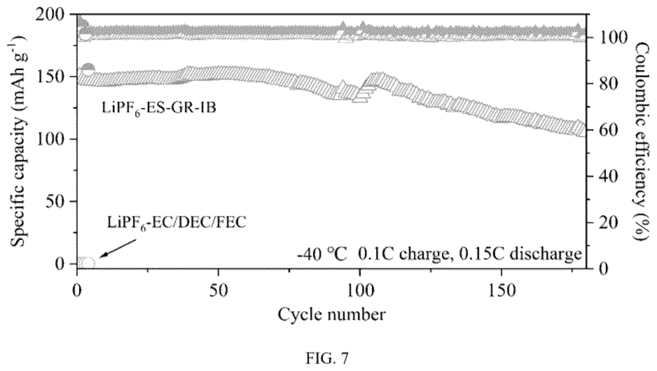

According to the embodiments of the subject invention, the LiPF₆-ES-GR-IB electrolyte can significantly enhance not only the rate performance of HV-LMBs but also their low-temperature performance. As shown in FIG. 7, the discharge capacity of the NCM811∥Li battery comprising the traditional LiPF₆-EC/DEC/FEC was nearly zero at a current density of 0.1 C for charging and 0.15 C for discharging under −40° C. In contrast, the NCM811∥Li battery comprising the LiPF₆-ES-GR-IB of the subject invention maintained a discharge capacity of 105.8 mAh g⁻¹ after 180 cycles under the same test conditions.

### Materials and Methods

### Experimental Setup

The preparation process of the NCM811 cathode includes uniformly mixing NCM811 powder with conductive carbon and the binder polyvinylidene fluoride (PVDF) in a mass ratio of 8:1:1, followed by stirring. The slurry is then coated onto an aluminum current collector. Subsequently, it is dried under vacuum at 80° C. for 12 hours.

All batteries were assembled in an argon-filled glovebox (H₂O<0.1 ppm, O₂<0.1 ppm). The cycling performance of batteries were tested under isothermal conditions using the NEWARE battery testing system. Electrochemical impedance spectroscopy (EIS) of batteries were conducted using an electrochemical workstation (Model VMP3, BioLogic).

The cost-efficiency electrolyte of the subject invention that is based on crystal regulation at the electrode-electrolyte interface includes ester solvents with low melting points (<−40° C.) and low dielectric constants (<10) as the co-solvent, and grain refiners and inhibitors as additives. This composition facilitates the formation of a CEI and SEI comprising a plurality of fine-grained LiF crystals, enhancing the stability of the SEI and CEI while reducing interfacial resistance. Consequently, improved cycling stability, rate capability, and low-temperature performance of HV-LMBs without increasing the cost of the electrolyte are achieved.

Embodiment 1. An electrolyte for lithium metal batteries, the electrolyte comprising:
at least one lithium salt selected from the group consisting of LiPF₆, Li(FSO₂)₂N, LiC(SO₂CF₃)₃, CF₃SO₃Li, LiN(SO₂CF₃)₂, lithium bisoxalatodifluorophosphate (LiDFBOP), Lithium difluoro(oxalato)borate (LiDFOB), LiB(C₂O₄)₂, LiBF₄, LiPF₃(CF₃)₃, LiPF₄(CF₃)₂, LiPF₅(CF₃), LiPF₃(CF₂CF₃)₃, LiNO₃, LiClO₄, LiAsF₆, Lithium trifluoromethanesulfonate (LiOTf), LiCF₃SO₃, LiCl, LiF, LiBr, LiI, and their mixtures;
at least one organic ester solvent defined by Formula 1 or 2:

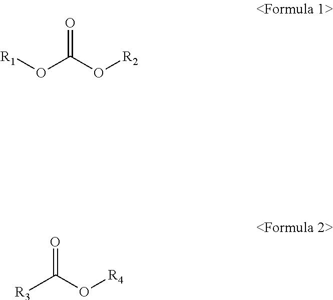

wherein R1-R4 in Formulas 1 and 2 are independently selected as substituted or unsubstituted C1-C20 alkyl groups;
a grain refiner defined by Formula 3:

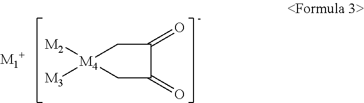

wherein in Formula 3, M1 represents a monovalent cation, M2 and M3 independently represent halogen elements, and M4 represents one of following elements: carbon, silicon, phosphorus, boron, selenium, or sulfur;
an inhibitor selected from the group consisting of Li₃N, LiF, Li₂CO₃, LiNO₃, LiPO₂F₂, HN(SO₂F)₂, Li₂O, Li₂C₂O₄, Li₂S, CH₂O₂NF₃S, LiBF₄, and their mixtures; and
a film-forming additive selected from fluoroethylene carbonate, 1,3,2-dioxathiolane 2,2-dioxide, vinylene carbonate, vinylethylene carbonate, propylene sulfite, ethylene sulfate, prop-1-ene-1,3-sultone, methylene methanedisulfonate, and their mixtures.

Embodiment 2. The electrolyte of embodiment 1, wherein the organic ester solvent accounts for 0.5% to 100% of a volume of the electrolyte.

Embodiment 3. The electrolyte of any preceding embodiment, wherein a concentration of the lithium salt is in a range between 0.1 M and 3 M.

Embodiment 4. The electrolyte of any preceding embodiment, wherein a concentration of the grain refiner is in a range between 0.05 M and 3 M.

Embodiment 5. The electrolyte of any preceding embodiment, wherein a concentration of the inhibitor is in a range between 0.02 M and 3 M.

Embodiment 6. The electrolyte of any preceding embodiment, wherein the film-forming additive accounts for 0% to 99.5% of a volume of the electrolyte.

Embodiment 7. A lithium battery comprising:
the electrolyte of any preceding embodiment;
a cathode; and
an anode.

Embodiment 8. The lithium battery of embodiment 7, wherein the cathode is made from a material selected from lithium-rich layered oxides, nickel-rich layered oxides, spinel oxides, and polyanionic compounds.

Embodiment 9. The lithium battery of any preceding embodiment, wherein the lithium-rich layered oxides include xLi₂MnO₃(1−x)·LiMO₂, wherein M is one of Ni, Co, and Mn.

Embodiment 10. The lithium battery of any preceding embodiment, wherein the nickel-rich layered oxides include LiNiO₂, LiNi₁₋ₓMₓO₂, Li[Ni_{1-x-y}CoₓMn_{y}]O₂, or Li[Ni_{1-x-y}CoₓAl_{y}]O₂, wherein M is one of Co and Mn.

Embodiment 11. The lithium battery of any preceding embodiment, wherein the spinel oxides include LiMn₂₋ₓMO₄, wherein M is one of Ni, Co, and Mn.

Embodiment 12. The lithium battery of any preceding embodiment, wherein the polyanionic compounds include phosphates, silicates, or sulfates.

Embodiment 13. The lithium battery of any preceding embodiment, wherein the anode is made from a material selected from lithium alloy or lithium metal.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

1. Li, M.; Lu, J.; Chen, Z.; Amine, K. Advanced Materials 2018, 30, (33), 1800561.
2. Manthiram, A. ACS Central Science 2017, 3, (10), 1063-1069.
3. Lin, D.; Liu, Y; Cui, Y Nature Nanotechnology 2017, 12, (3), 194-206.
4. Cheng, X. B.; Zhang, R.; Zhao, C. Z.; Zhang, Q. Chem Rev 2017, 117, (15), 10403-10473.
5. Zhang, S.; Li, R.; Deng, T.; Ma, Q.; Hong, X.; Zhang, H.; Zhang, R.; Ding, S.; Wu, Y; Zhu, H.; Li, M.; Zhang, H.; Lu, D.; Ma, B.; Lv, L.; Li, Y; Chen, L.; Shen, Y; Guo, R.; Fan, X. Nature Energy 2024.
6. Xue, W; Huang, M.; Li, Y; Zhu, Y G.; Gao, R.; Xiao, X.; Zhang, W.; Li, S.; Xu, G.; Yu, Y; Li, P.; Lopez, J.; Yu, D.; Dong, Y; Fan, W.; Shi, Z.; Xiong, R.; Sun, C.-J.; Hwang, I.; Lee, W.-K.; Shao-Horn, Y; Johnson, J. A.; Li, J. Nature Energy 2021, 6, (5), 495-505.
7. Liu, J.; Bao, Z.; Cui, Y; Dufek, E. J.; Goodenough, J. B.; Khalifah, P.; Li, Q.; Liaw, B. Y; Liu, P.; Manthiram, A.; Meng, Y S.; Subramanian, V. R.; Toney, M. F.; Viswanathan, V. V.; Whittingham, M. S.; Xiao, J.; Xu, W; Yang, J.; Yang, X.-Q.; Zhang, J.-G. Nature Energy 2019, 4, (3), 180-186.
8. Ren, X.; Zou, L.; Cao, X.; Engelhard, M. H.; Liu, W.; Burton, S. D.; Lee, H.; Niu, C.; Matthews, B. E.; Zhu, Z.; Wang, C.; Arey, B. W.; Xiao, J.; Liu, J.; Zhang, J.-G.; Xu, W. Joule 2019, 3, (7), 1662-1676.
9. Wang, H.; Yu, Z.; Kong, X.; Kim, S. C.; Boyle, D. T.; Qin, J.; Bao, Z.; Cui, Y Joule 2022, 6, (3), 588-616.
10. Zhang, H.; Eshetu, G. G.; Judez, X.; Li, C.; Rodriguez-Martinez, L. M.; Armand, M. Angew Chem Int Ed Engl 2018, 57, (46), 15002-15027.
11. Fan, X.; Chen, L.; Ji, X.; Deng, T.; Hou, S.; Chen, J.; Zheng, J.; Wang, F.; Jiang, J.; Xu, K.; Wang, C. Chem 2018, 4, (1), 174-185.
12. Chen, S.; Zheng, J.; Mei, D.; Han, K. S.; Engelhard, M. H.; Zhao, W.; Xu, W.; Liu, J.; Zhang, J. G. Adv Mater 2018, 30, (21), e1706102.
13. Li, A. M.; Borodin, O.; Pollard, T. P.; Zhang, W.; Zhang, N.; Tan, S.; Chen, F.; Jayawardana, C.; Lucht, B. L.; Hu, E.; Yang, X. Q.; Wang, C. Nat Chem 2024, 16, (6), 922-929.
14. Xiang, J.; Lu, Y C. ACS Nano 2024, 18, (16), 10726-10737.
15. Zhang, J.; Zhang, H.; Weng, S.; Li, R.; Lu, D.; Deng, T.; Zhang, S.; Lv, L.; Qi, J.; Xiao, X.; Fan, L.; Geng, S.; Wang, F.; Chen, L.; Noked, M.; Wang, X.; Fan, X. Nat Commun 2023, 14, (1), 2211.
16. Wan, H.; Xu, J.; Wang, C. Nat Rev Chem 2024, 8, (1), 30-44.
17. Hobold, G. M.; Wang, C.; Steinberg, K.; Li, Y; Gallant, B. M. Nature Energy 2024, 9, (5), 580-591.
18. Thenappan, T.; Devaraj, A. P. Journal of Molecular Liquids 2006, 123, (2-3), 72-79.
19. Reznitskikh, O. G.; Istomina, A. S.; Borisevich, S. S.; Evshchik, E. Y; Sanginov, E. A.; Bushkova, O. V.; Dobrovolsky, Y A. Russian Journal of Physical Chemistry A 2021, 95, (6), 1121-1127.
20. Karkar, Z.; Whitfield, P. S.; Abu-Lebdeh, Y Crystal Growth & Design 2024.
21. Xu, J.; Zhang, J.; Pollard, T. P.; Li, Q.; Tan, S.; Hou, S.; Wan, H.; Chen, F.; He, H.; Hu, E.; Xu, K.; Yang, X. Q.; Borodin, O.; Wang, C. Nature 2023, 614, (7949), 694-700.
22. Xu, K. Chem Rev, 2004, 104(10), 4303-4418.
23. Xu, K. Chem Rev 2014, 114, (23), 11503-618.

We claim:

1. An electrolyte for lithium metal batteries, the electrolyte comprising:
at least one lithium salt selected from the group consisting of LiPF₆, Li(FSO₂)₂N, LiC(SO₂CF₃)₃, CF₃SO₃Li, LiN(SO₂CF₃)₂, lithium bisoxalatodifluorophosphate (LiDFBOP), Lithium difluoro(oxalato)borate (LiDFOB), LiB(C₂O₄)₂, LiBF₄, LiPF₃(CF₃)₃, LiPF₄(CF₃)₂, LiPF₅(CF₃), LiPF3(CF2CF3)3, LiNO₃, LiClO₄, LiAsF₆, lithium trifluoromethanesulfonate (LiOTf), LiCF₃SO₃, LiCl, LiF, LiBr, LiI, and any combination thereof,
at least one organic ester solvent defined by Formula 1 or 2: 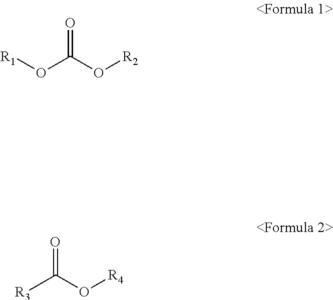
wherein R1-R4 in Formulas 1 and 2 are independently selected as substituted or unsubstituted C1-C20 alkyl groups;
a grain refiner defined by Formula 3: 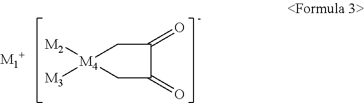
wherein in Formula 3, M1 represents a monovalent cation, M2 and M3 independently represent halogen elements, and M4 represents one of following elements: carbon, silicon, phosphorus, boron, selenium, or sulfur;
an inhibitor selected from the group consisting of Li₃N, LiF, Li₂CO₃, LiNO₃, LiPO₂F₂, HN(SO2F)₂, Li₂O, Li₂C₂O₄, Li₂S, CH₂O₂NF₃S, LiBF₄, and any combination thereof, and
a film-forming additive selected from fluoroethylene carbonate, 1,3,2-dioxathiolane 2,2-dioxide, vinylene carbonate, vinylethylene carbonate, propylene sulfite, ethylene sulfate, prop-1-ene-1,3-sultone, methylene methanedisulfonate, and any combination thereof.

2. The electrolyte of claim 1, wherein the organic ester solvent accounts for 0.5% to 100% of a volume of the electrolyte.

3. The electrolyte of claim 1, wherein a concentration of the grain refiner is in a range between 0.05 M and 3 M.

4. The electrolyte of claim 1, wherein a concentration of the inhibitor is in a range between 0.02 M and 3 M.

5. The electrolyte of claim 1, wherein the film-forming additive accounts for 0% to 99.5% of a volume of the electrolyte.

6. A lithium battery comprising:
the electrolyte of claim 1;
a cathode; and
an anode.

7. The lithium battery of claim 6, wherein the cathode is made from a material selected from lithium-rich layered oxides, nickel-rich layered oxides, spinel oxides, and polyanionic compounds.

8. The lithium battery of claim 7, wherein the lithium-rich layered oxides include xLi₂MnO₃(1−x)·LiMO₂, wherein M is Ni, Co, or Mn.

9. The lithium battery of claim 7, wherein the nickel-rich layered oxides include LiNiO₂, LiNi₁₋ₓMₓO₂, Li[Ni_{1-x-y}CoₓMn_{y}]O₂, or Li[Ni_{1-x-y}CoₓAl_{y}]O₂, wherein M is Co or Mn.

10. The lithium battery of claim 7, wherein the spinel oxides include LiMn₂₋ₓMO₄, wherein M is Ni, Co, or Mn.

11. The lithium battery of claim 7, wherein the polyanionic compounds include phosphates, silicates, or sulfates.

12. The lithium battery of claim 6, wherein the anode is made from a material selected from lithium alloy or lithium metal.
